(19) United States
(12) Patent Application Publication
(10) Pub. No.: US 2021/0209914 A1
(43) Pub. Date: Jul. 8, 2021

(54) VEHICLE SMOKE DETECTION SYSTEM AND METHOD THEREFOR

(71) Applicant: HOWARD B. KATZ, BOCA RATON, FL (US)

(72) Inventor: HOWARD B. KATZ, BOCA RATON, FL (US)

(21) Appl. No.: 17/138,598

(22) Filed: Dec. 30, 2020

Related U.S. Application Data
(60) Provisional application No. 62/956,806, filed on Jan. 3, 2020.

(51) Int. Cl. G08B 17/10; G08B 17/12; G08B 21/18; G08B 25/10; G08B 29/14; G07C 5/08; G07C 5/00; H04W 4/40; H04W 4/80; H04W 4/90; G06K 9/00

(52) U.S. Cl. CPC G08B 17/10; G08B 17/125; G08B 21/182; G08B 25/10; G08B 29/145; G06K 9/00832; G07C 5/008; H04W 4/40; H04W 4/80; H04W 4/90; G07C 5/0866

(57) ABSTRACT

A smoke detecting system for an interior of a vehicle has a smoke detection circuit monitoring for smoke within the interior of the vehicle. The smoke detecting circuit records a date and time when the smoke detection circuit monitors a smoke level above a predetermined value.

### RELATED APPLICATIONS

This patent application is related to U.S. Provisional Application No. 62/956,800 filed Jan. 3, 2020, entitled “KEYFREE SMOKE DETECTION”, in the name of Howard Katz, and which is incorporated herein by reference in its entirety. The present patent application claims the benefit under 35 U.S.C § 119(e).

### TECHNICAL FIELD

The present application in general relates to a smoke detection system, and more specifically, to a smoke detection system for an interior of a vehicle that is able to monitor and record when an individual may be using a smoking article within the interior of the vehicle.

### BACKGROUND

Smoking has become less and less tolerated in all areas of everyday life. The changing attitude may also be reflected in the way car companies look at smoking. These days, many car companies have changed cigarette lighters into power sockets. In fact, many car companies may charge the client extra if a cigarette lighter is requested. Car companies have also replaced the ashtray with a coin holder or other types of storage compartments.

In a study funded by an anti-tobacco group, it was found that 4000 chemicals may be found in secondhand smoke. The study also found that the nicotine levels may be 30 times higher in smoker's cars than ones which are tobacco free. It may be for these reasons that more than 90 percent of non-smokers banned any sort of tobacco, cannabis and/or vaping ignition in their cars. When tobacco, cannabis and/or vaping is smoked in the enclosed environments of passenger cars, air concentrations of smoke pollutants can become extremely high. Many of the pollutants may attach to surfaces and accumulate in duster from where they can be released back into the air over days and weeks after smoking.

Because of the damage cigarette, cannabis and/or vaping smoke may do to the interior of a vehicle, automobiles sold by smokers and automobiles that had been smoked in are generally offered at a significantly lower prices than equivalent cars offered by nonsmokers and in which no smoking was reported. Studies have shown that the value of the automobile decreases by 7.5% if the automobile was sold by a smoker compared to an equivalent car sold by a nonsmoker.

Because of the damage cigarette and other smoking articles smoke may do to the interior of a vehicle, many rental car companies as well as companies that provide vehicles to their employees may limit and/or prohibit smoking in the vehicles. However, many times, individuals fail to obey company policy and may still smoke inside the vehicle. When an individual does smoke in a rental and/or company vehicle, it may be difficult to determine which individual may be responsible for the smoke damage.

Therefore, it would be desirable to provide a system and method that overcomes the above.

### SUMMARY

In accordance with one embodiment, a smoke detecting system for an interior of a vehicle is disclosed. The smoke detecting system has a smoke detection circuit monitoring for smoke within the interior of the vehicle. The smoke detecting circuit records a date and time when the smoke detection circuit monitors a smoke level above a predetermined value.

In accordance with one embodiment, a smoke detecting system for an interior of a vehicle is disclosed. The smoke detecting system has a smoke detection circuit monitoring for smoke within the interior of the vehicle. The smoke detecting circuit records a date and time when the smoke detection circuit monitors a smoke level above a predetermined value. The smoke detection circuit has at least one smoke detection sensor positioned within the interior of the vehicle. An Electronic Control Unit (ECU) is coupled to the at least one smoke detection sensor controlling operation of the at least one smoke detection sensor. The ECU stores data related to when the at least one smoke detection sensor detects smoke particulates within the interior of the vehicle above the predetermined threshold. The ECU records the time and day the at least one smoke detection sensor detects smoke particulates within the interior of the vehicle above the predetermined threshold. A Global Positioning System (GPS) unit is coupled to the ECU indicating a location where the at least one smoke detection sensor detects smoke particulates within the interior of the vehicle above the predetermined threshold. The location is stored within the ECU.

In accordance with one embodiment, a smoke detecting system for an interior of a vehicle is disclosed. The smoke detecting system has a smoke detection circuit monitoring for smoke within the interior of the vehicle. The smoke detecting circuit records a date and time when the smoke detection circuit monitors a smoke level above a predetermined value. The smoke detection circuit has at least one smoke detection sensor positioned within the interior of the vehicle. An Electronic Control Unit (ECU) is coupled to the at least one smoke detection sensor controlling operation of the at least one smoke detection sensor. The ECU stores data related to when the at least one smoke detection sensor detects smoke particulates within the interior of the vehicle above the predetermined threshold. The ECU records the time and day the at least one smoke detection sensor detects smoke particulates within the interior of the vehicle above the predetermined threshold. A Global Positioning System (GPS) unit is coupled to the ECU indicating a location where the at least one smoke detection sensor detects smoke particulates within the interior of the vehicle above the predetermined threshold. The location is stored within the ECU. A recording device is coupled to the ECU recording one or more images of the interior of the vehicle when the at least one smoke detection sensor detects smoke particulates within the interior of the vehicle above the predetermined threshold. The one or more images stored within the ECU. A receiver/transmitter is coupled to the ECU transmitting the time and day, location and the one or more images when the at least one smoke detection sensor detects smoke particulates within the interior of the vehicle above the predetermined threshold. The receiver/transmitter performs at least one of transmits the time and day, the location and the one or more images to a computing device using a Personal Area Network (PAN) using one of ANT+, Bluetooth, IEEE 802.15 TG3, IEEE 802.15 TG4, or similar standards or transmits the time and day, the location and the one or more images to a server when the at least one smoke detection sensor detects smoke particulates within the interior of the vehicle above the predetermined threshold via one of a local area network (LAN), a general wide area network (WAN), wireless local area network (WLAN) and/or a public network.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a schematic view of an exemplary vehicle smoke detecting system according to one aspect of the present application;

FIG. 2 is a block diagram of an exemplary smoke detecting circuit of the system depicted in FIG. 1 in accordance with one aspect of the present application; and

FIG. 3 is a flow chart showing an exemplary operation of the smoke detecting circuit of the system depicted in FIG. 1 in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method relates to a vehicle smoke detection system. The vehicle smoke detection system may continuously monitor a vehicle for the detection of smoke particles. Upon detection of smoke particles above a predefined value, the vehicle smoke detection system may log the event. The logged information may include a time, a location, smoke particulate readings, as well as other similar data. The data logged by the vehicle smoke detection system may be downloaded by an owner of the vehicle. The downloaded data may be used by the owner to charge the vehicle user for smoking violations in the vehicle.

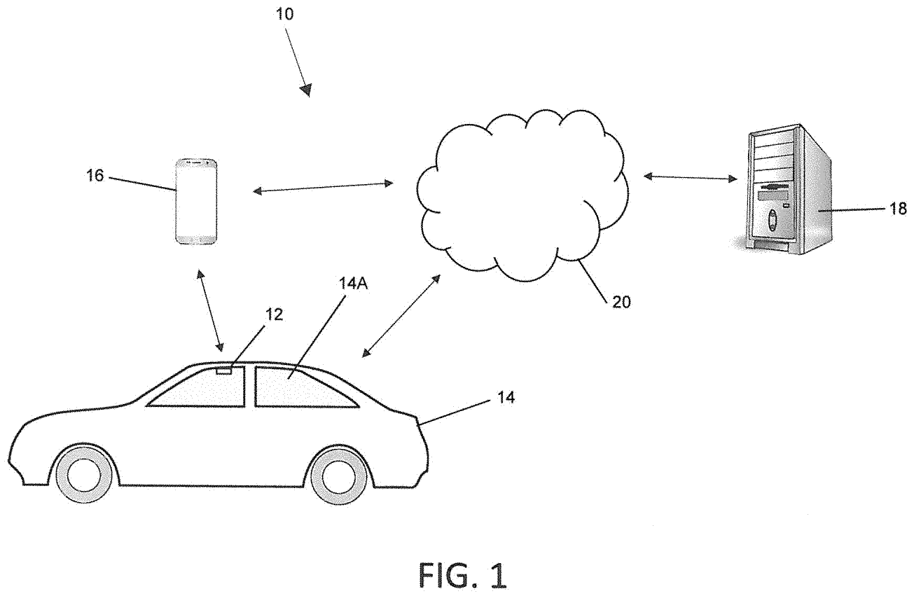

Referring now to FIG. 1, a vehicle smoke detection system 10 (hereinafter system 10) may be seen. The system 10 may be used by any owner of a vehicle 14 who may wish to monitor whether users of the vehicle 14 have been smoking inside the vehicle 14. More specifically, the system 10 may be used by owners of a fleet of vehicles 14, who may wish to monitor whether users of the vehicle 14 are smoking inside the vehicle 14, such as car rental agencies, companies that provide employees with company vehicles, law enforcement departments, car sharing operations and the like. The above listing is given as an example and should not be seen in a limiting manner.

The system 10 may have a smoke monitoring circuit 12 (hereinafter circuit 12) installed within an interior 14A of a vehicle 14. Each circuit 12 may be registered with a specific Vehicle Identification Number (VIN) of the vehicle 14. The circuit 12 may monitor the interior 14A of the vehicle 14 for smoke. If the monitored value of smoke detected exceeds a predetermined value, the circuit 12 may record a date and time of the occurrence. The predetermined value may be set to any level. This may allow the circuit 12 to prevent false detection of smoke. For example, a higher setting may prevent the circuit 12 from recording the occurrence of smoke detection when there may be smoke outside of the vehicle 14 but the windows of the vehicle 14 may be down. Thus, occurrences such as second-hand smoke from people outside of the vehicle 14, smoke from grills/fireplaces, and the like should not be sufficient to cause the circuit 12 to record a date and time of the occurrence.

When a user returns the vehicle 14 to the owner, the owner may use a computing device 16 to download data from the circuit 12. The computing device 16 may be a personal computer system, tablet device, handheld or laptop device, mobile phone device, server computer system, multiprocessor system, microprocessor-based system, set top boxes, programmable consumer electronics, network PCs, and distributed cloud computing environments that include any of the above systems or devices, and the like.

The data may be downloaded to the computing device 16 via wire or wireless means. For example, the computing device 16 may be plugged into via a wired connection to a connector 36 on an On-board Diagnostic (OBD) unit or Electronic Control Unit/Module (ECU/ECM) (hereinafter ECU) 24 of the vehicle 14. Alternatively, or in addition to, the computing device 16 may download the data wirelessly from the circuit 12. The computing device 16 may download the data wirelessly using a Personal Area Network (PAN) using wireless technologies such as, but not limited to, ANT+, Bluetooth, IEEE 802.15 TG3, IEEE 802.15 TG4, or similar standards.

Once the computing device 16 has downloaded the data form the circuit 12, the downloaded data may be used by the owner to charge the user of the vehicle 14 for smoking violations in the vehicle 14. The computing device 16 may also upload the data to a server 18 for storage of the data. The computing device 16 may connect to a network 20. The network 20 may be a local area network (LAN), a general wide area network (WAN), wireless local area network (WLAN) and/or a public network. Once connected to the network 20, the computing device 16 may upload and transfer the data to the server 18 via the network 20.

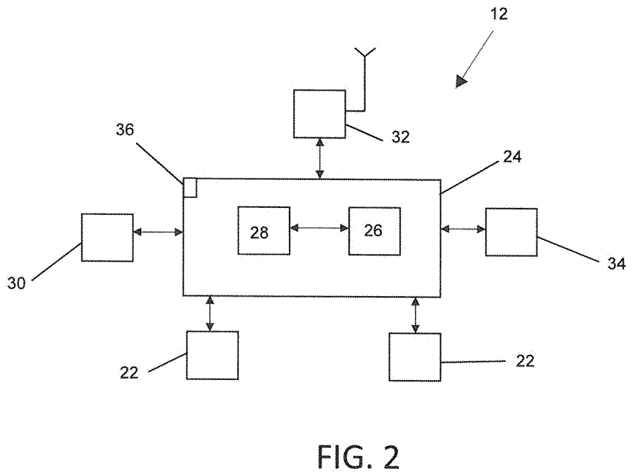

Referring to FIGS. 1 and 2, the circuit 12 may be disclosed in further details. The circuit 12 may have one or more smoke detecting sensors 22. The smoke detecting sensors 22 may be positioned in an interior 14A of the vehicle 14. In accordance with one embodiment, multiple smoke detecting sensors 22 may be positioned within a passenger compartment of the vehicle 14. Different types of technologies may be used for the smoke detecting sensors 22. For example, ionization, light/laser or other technologies may be used for detecting smoke in the interior 14A of the vehicle 14. In accordance with one embodiment, a model LD09 particle sensor by Guangzhou Luftmy Intelligence Technology Co may be used as the smoke detecting sensor 22.

The smoke detecting sensors 22 may have an adapter for coupling the smoke detecting sensor 22 to an electronic control unit (ECU) 24 of the vehicle 14. Most vehicles 14 have one or more ECUs 24. The ECU 24 may be used to controls one or more electrical systems in that vehicle 14. Thus, the ECU 24 may control operation of the smoke detecting sensors 22. The ECU 24 may determine when the smoke detecting sensors 22 is activated, which smoke detecting sensors 22 are active, how often the smoke detecting sensors 22 may take samples, and as well as other similar functions.

When the smoke detecting sensors 22 is active and monitoring the interior of the vehicle 14, readings from the smoke detecting sensors 22 may be sent to a microcontroller 26 of the ECU 24. The microcontroller 26 may analyze the data received to determine if the monitored value of smoke detected exceeds a predetermined value. If the microcontroller 26 determines that the monitored value of smoke detected exceeds a predetermined value, the microcontroller 26 may record a time/date of the reading and store this in a memory 28 of the ECU 24. The microcontroller 26 may also record the value of smoke detected by the smoke detecting sensors 22 and store this value in memory 28. The memory 28 may be a separate memory device and/or a memory unit of the microcontroller 26.

In accordance with one embodiment, a Global Positioning System (GPS) unit 30 may be coupled to the ECU 24. The GPS unit 30 may be a navigation unit of the vehicle 14. Alternatively, the GPS unit 30 may just be a tracking unit. The GPS unit 30 may be used to monitor a current location of the vehicle 14. When the microcontroller 26 determines that the monitored value of smoke detected exceeds a predetermined value, the microcontroller 26 may record a time/date of the reading, value of the smoke level detected as well as a current location of the vehicle 14. This information may then be store in the memory 28 of the ECU 24.

The circuit 12 may have a recording device 34. The recording device 34 may be coupled to the ECU 24. In accordance with one embodiment, the recording device 34 may be a camera, a video recorder, or similar devices. When the microcontroller 26 determines that the monitored value of smoke detected exceeds a predetermined value, the microcontroller 26 may signal the recording device 34 to make a recording of the interior 14A of the vehicle 14. Thus, the circuit 12 may have documentation of those inside the vehicle 14 when the microcontroller 26 determines that the monitored value of smoke detected exceeds a predetermined value. The recorded data from the recording device 34 may be store in the memory 28 of the ECU 24.

The circuit 12 may have a receiver/transmitter 32. The receiver/transmitter 32 may be coupled to the ECU 24. The receiver/transmitter 32 may allow wireless transmission of data to and from the vehicle 14. The receiver/transmitter 32 may be used to wirelessly transmit data stored in the memory 28 to the computing device 16 in different manners. In accordance with one embodiment, the computing device 16 may need to be within a short range of the receiver/transmitter 32. The computing device 16 may then download the data wirelessly using a Personal Ara Network (PAN) using wireless technologies such as, but not limited to, ANT+, Bluetooth, IEEE 802.15 TG3, IEEE 802.15 TG4, or similar standards.

In accordance with one embodiment, when the microcontroller 26 determines that the monitored value of smoke detected exceeds a predetermined value, the microcontroller 26 may signal the receiver/transmitter 32 to transmit this data to the server 18 via the network 20. The network 20 may be a local area network (LAN), a general wide area network (WAN), wireless local area network (WLAN) and/or a public network. Once connected to the network 20, the receiver/transmitter 32 may transmit the data stored in the memory 28 to the server 18. The server 18 may then transmit this data to the owner of the vehicle 14 and/or the computing device 16. The server 18 may transmit this data to the owner of the vehicle 14 via email, text, and/or other similar notification methods. The data transmitted may be the time/date of the event, the level of the smoke detected, the location of where the event took place and one or more images of the interior 14A of the vehicle 14 when the event occurred.

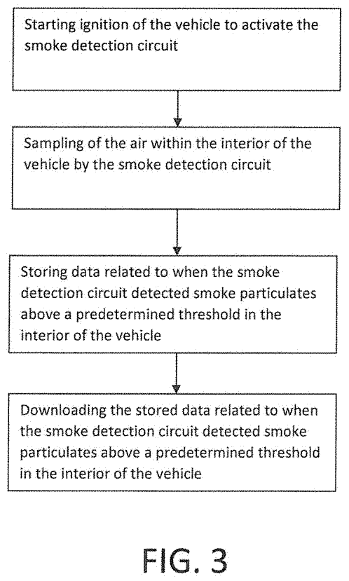

Referring to FIGS. 1-3, operation of the system 10 may be disclosed. When the ignition of the vehicle 14 is started by a user, the circuit 12 may be activated and may begin to determine the presence of smoke within the interior 14A of the vehicle 14. The circuit 12 may be programed so that the smoke detecting sensors 22 continuously determines the presence of smoke within the interior 14A of the vehicle 14 or alternatively may be programmed to take air samples within the interior 14A of the vehicle 14 at predetermines intervals, such as every 5 sees or the like.

When the smoke detecting sensors 22 is active and monitoring the interior of the vehicle 14, readings from the smoke detecting sensors 22 may be sent to a microcontroller 26 of the ECU 24. The microcontroller 26 may analyze the data received to determine if the monitored value of smoke detected exceeds a predetermined value. If the microcontroller 26 determines that the monitored value of smoke detected exceeds a predetermined value, the microcontroller 26 may record a time/date of the reading and store this data in the memory 28 of the ECU 24.

If the circuit 12 has a GPS unit 30, when the microcontroller 26 determines that the monitored value of smoke detected exceeds a predetermined value, the microcontroller 26 may record a time/date of the reading as well as a current location of the vehicle 14 indicated by the GPS unit 30. This information may then be store in the memory 28 of the ECU 24.

If the circuit 12 has a recording device 34. When the microcontroller 26 determines that the monitored value of smoke detected exceeds a predetermined value, the microcontroller 26 may signal the recording device 34 to make a recording of the interior 14A of the vehicle 14. This data may then be stored in the memory 28 of the ECU 24. Thus, the circuit 12 may have documentation of those inside the vehicle 14 when the event occurred.

Data stored in the memory 28 may be transferred to the computing device 16. The data may be transferred by a wired connection or wirelessly. In a wired connection, the computing device 16 may be plugged into a connector 36 via a wired connection to the ECU 24 of the vehicle 14. Alternatively, the receiver/transmitter 32 may be used to wirelessly transmit the data stored in the memory 28 to the computing device 16. In accordance with one embodiment, the computing device 16 may need to be within a short range of the receiver/transmitter 32. The computing device 16 may then download the data wirelessly using a Personal Area Network (PAN) using wireless technologies such as, but not limited to, ANT+, Bluetooth, IEEE 802.15 TG3, IEEE 802.15 TG4, or similar standards.

In accordance with one embodiment, when the microcontroller 26 determines that the monitored value of smoke detected exceeds a predetermined value, the microcontroller 26 may signal the receiver/transmitter 32 to transmit this data to the server 18 via the network 20. The network 20 may be a local area network (LAN), a general wide area network (WAN), wireless local area network (WLAN) and/or a public network. Once connected to the network 20, the receiver/transmitter 32 may transmit the data stored in the memory 28 to the server 18. The server 18 may then transmit this data to the owner of the vehicle 14 and/or the computing device 16. The server 18 may transmit this data to the owner of the vehicle 14 via email, text, and/or other similar notification methods. The data transmitted may be the time/date of the event, the level of the smoke detected, the location of where the event took place and one or more images of the interior 14A of the vehicle 14 when the event occurred.

The foregoing description is illustrative of particular embodiments of the invention, but is not meant to be a limitation upon the practice thereof. The following claims, including all equivalents thereof, are intended to define the scope of the invention.

What is claimed is:

1. A smoke detecting system for an interior of a vehicle comprising:
a smoke detection circuit monitoring for smoke within the interior of the vehicle, the smoke detecting circuit recording a date and time when the smoke detection circuit monitors a smoke level above a predetermined value.

2. The system of claim 1, wherein the smoke detection circuit comprises:
at least one smoke detection sensor positioned within the interior of the vehicle; and
an Electronic Control Unit (ECU) coupled to the at least one smoke detection sensor controlling operation of the at least one smoke detection sensor, the ECU storing data related to when the at least one smoke detection sensor detects smoke particulates within the interior of the vehicle above the predetermined threshold.

3. The system of claim 2, wherein the ECU records a time and day the at least one smoke detection sensor detects smoke particulates within the interior of the vehicle above the predetermined threshold.

4. The system of claim 2, wherein the smoke detection circuit comprises a Global Positioning System (GPS) unit coupled to the ECU indicating a location where the at least one smoke detection sensor detects smoke particulates within the interior of the vehicle above the predetermined threshold.

5. The system of claim 2, wherein the smoke detection circuit comprises a recording device coupled to the ECU recording one or more images of the interior of the vehicle when the at least one smoke detection sensor detects smoke particulates within the interior of the vehicle above the predetermined threshold.

6. The system of claim 2, wherein the smoke detection circuit comprises a connector attaching a computing device to the ECU to download the data stored within the ECU data related to when the at least one smoke detection sensor detects smoke particulates within the interior of the vehicle above the predetermined threshold.

7. The system of claim 2, wherein the smoke detection circuit comprises a receiver/transmitter coupled to the ECU transmitting the data stored within the ECU data related to when the at least one smoke detection sensor detects smoke particulates within the interior of the vehicle above the predetermined threshold.

8. The system of claim 7, wherein the smoke detecting system comprises a computing device, the receiver/transmitter wirelessly transmits the data stored within the ECU data related to when the at least one smoke detection sensor detects smoke particulates within the interior of the vehicle above the predetermined threshold to the computing device using a Personal Area Network (PAN).

9. The system of claim 8, wherein the receiver/transmitter wirelessly transmits the data using one of ANT+, Bluetooth, IEEE 802.15 TG3, IEEE 802.15 TG4, or similar standards.

10. The system of claim 7, wherein the smoke detecting system comprises a server, the receiver/transmitter wirelessly transmits the data stored within the ECU data related to when the at least one smoke detection sensor detects smoke particulates within the interior of the vehicle above the predetermined threshold to the server.

11. The system of claim 10, wherein the receiver/transmitter wirelessly transmits the data stored within the ECU data related to when the at least one smoke detection sensor detects smoke particulates within the interior of the vehicle above a predetermined threshold to the server via one of a local area network (LAN), a general wide area network (WAN), wireless local area network (WLAN) and/or a public network.

12. The system of claim 12, wherein the smoke detecting system comprises a computing unit coupled to the server receiving notifications of when the at least one smoke detection sensor detects smoke particulates within the interior of the vehicle above the predetermined threshold.

13. A smoke detecting system for an interior of a vehicle comprising:
a smoke detection circuit monitoring for smoke within the interior of the vehicle, the smoke detecting circuit recording a date and time when the smoke detection circuit monitors a smoke level above a predetermined value, wherein the smoke detection circuit comprises:
at least one smoke detection sensor positioned within the interior of the vehicle;
an Electronic Control Unit (ECU) coupled to the at least one smoke detection sensor controlling operation of the at least one smoke detection sensor, the ECU storing data related to when the at least one smoke detection sensor detects smoke particulates within the interior of the vehicle above the predetermined threshold, wherein the ECU records the time and day the at least one smoke detection sensor detects smoke particulates within the interior of the vehicle above the predetermined threshold; and
a Global Positioning System (GPS) unit coupled to the ECU indicating a location where the at least one smoke detection sensor detects smoke particulates within the interior of the vehicle above the predetermined threshold, the location stored within the ECU.

14. The system of claim 13, wherein the smoke detection circuit comprises a recording device coupled to the ECU recording one or more images of the interior of the vehicle when the at least one smoke detection sensor detects smoke particulates within the interior of the vehicle above the predetermined threshold.

15. The system of claim 13, wherein the smoke detection circuit comprises a connector attaching a computing device to the ECU to download the data stored within the ECU data related to when the at least one smoke detection sensor detects smoke particulates within the interior of the vehicle above the predetermined threshold.

16. The system of claim 13, wherein the smoke detection circuit comprises a receiver/transmitter coupled to the ECU transmitting the data stored within the ECU data related to when the at least one smoke detection sensor detects smoke particulates within the interior of the vehicle above the predetermined threshold.

17. The system of claim 16, wherein the smoke detecting system comprises a computing device, the receiver/transmitter wirelessly transmits the data stored within the ECU data related to when the at least one smoke detection sensor detects smoke particulates within the interior of the vehicle above the predetermined threshold to the computing device using a Personal Area Network (PAN), wherein the receiver/transmitter wirelessly transmits the data using one of ANT+, Bluetooth, IEEE 802.15 TG3, IEEE 802.15 TG4, or similar standards.

18. The system of claim 16, wherein the smoke detecting system comprises a server, the receiver/transmitter wirelessly transmits the data stored within the ECU data related to when the at least one smoke detection sensor detects smoke particulates within the interior of the vehicle above the predetermined threshold to the server.

19. The system of claim 18, wherein the receiver/transmitter wirelessly transmits the data stored within the ECU data related to when the at least one smoke detection sensor detects smoke particulates within the interior of the vehicle above a predetermined threshold to the server via one of a local area network (LAN), a general wide area network (WAN), wireless local area network (WLAN) and/or a public network.

20. A smoke detecting system for an interior of a vehicle comprising:
a smoke detection circuit monitoring for smoke within the interior of the vehicle, the smoke detecting circuit recording a date and time when the smoke detection circuit monitors a smoke level above a predetermined value, wherein the smoke detection circuit comprises:
at least one smoke detection sensor positioned within the interior of the vehicle;
an Electronic Control Unit (ECU) coupled to the at least one smoke detection sensor controlling operation of the at least one smoke detection sensor, the ECU storing data related to when the at least one smoke detection sensor detects smoke particulates within the interior of the vehicle above the predetermined threshold, wherein the ECU records the time and day the at least one smoke detection sensor detects smoke particulates within the interior of the vehicle above the predetermined threshold;
a Global Positioning System (GPS) unit coupled to the ECU indicating a location where the at least one smoke detection sensor detects smoke particulates within the interior of the vehicle above the predetermined threshold, the location stored within the ECU;
a recording device coupled to the ECU recording one or more images of the interior of the vehicle when the at least one smoke detection sensor detects smoke particulates within the interior of the vehicle above the predetermined threshold, the one or more images stored within the ECU;
a receiver/transmitter coupled to the ECU transmitting the time and day, the location and the one or more images when the at least one smoke detection sensor detects smoke particulates within the interior of the vehicle above the predetermined threshold;
wherein the receiver/transmitter performs at least one of transmits the time and day, the location and the one or more images to a computing device using a Personal Area Network (PAN) using one of ANT+, Bluetooth, IEEE 802.15 TG3, IEEE 802.15 TG4, or similar standards or transmits the time and day, the location and the one or more images to a server when the at least one smoke detection sensor detects smoke particulates within the interior of the vehicle above the predetermined threshold via one of a local area network (LAN), a general wide area network (WAN), wireless local area network (WLAN) and/or a public network.
